(19) United States
(12) Patent Application Publication
(10) Pub. No.: US 2026/0249481 A1
(43) Pub. Date: Aug. 27, 2026

(54) THERMIC VERIFICATION OF GLUE IN LASH APPLICATIONS

(71) Applicant: L'Oreal, Paris (FR)

(72) Inventor: Rafael FELICIANO, New Providence, NJ (US)

(73) Assignee: L'Oreal, Paris (FR)

(21) Appl. No.: 19/065,064

(22) Filed: Feb. 27, 2025

(51) Int. Cl. B25J 11/00; B25J 9/16; B25J 19/02

(52) U.S. Cl. CPC B25J 11/008; B25J 9/1679; B25J 19/021

(57) ABSTRACT

A system for applying lash extensions onto natural lashes includes a thermal camera; a robotic device; lash extensions; a glue well including a glue that undergoes exothermic or endothermic reaction; a computer and a tangible computer-readable medium having stored thereon instructions that when executed perform the following steps: control the robotic device to pick up a lash extension; control the robotic device to apply glue to the lash extension; control the robotic device to place the lash extension on a natural lash; control the robotic device to release the lash extension; measure, via the thermal camera, a temperature of the glue; and after the temperature of the glue is at a predetermined target temperature, the robotic device places a second lash extension on a second natural lash.

### SUMMARY

Applying a lash extension to a natural eyelash of a person can be a time consuming process. Time is spent waiting for the glue to cure on one lash extension before the next lash extension can be applied so as not to disturb the position of the previously applied lash extension. However, determining whether a glue is fully cured is an extremely difficult process since it is a function of glue thickness, ambient temperature, and required holding force.

This disclosure takes advantage that certain glues have a thermic reaction during the curing process. This disclosure relates to a system and a method to analyze the temperature of glues to use as a marker for cure time to provide the sufficient holding force.

The disclosure relates to the use of a thermal camera to measure the presence of a glue during the curing process. The use of a computer to measure the temperature and time the thermic reaction.

In embodiments, the system includes a computer that can analyze sensory inputs and perform calculations and execute machine instructions. In embodiments, the system includes a thermal camera, calibrated and positioned to measure the temperature of the lash extensions during the glue curing process.

In embodiments, an optional catalyst is used to increase the speed of curing of the glue.

In embodiments, the glue is an endothermic glue (e.g. nitrocellulose) or an exothermic glue (UV curable).

In embodiments, a user or automated robotic system applies glue to attach a lash extension to a user's lash.

In embodiments, a predetermined target temperature is used in determining the minimum holding force needed for the lash extension being held securely.

In embodiments, the predetermined target temperature is dependent on the glue used and the required holding force.

In embodiments, lash extension application is done automatically by the robotic device or manually.

In embodiments, methods of lash extension application include steps, such applying glue to the lash extension or to the natural lash, and a computer optionally determines to apply a catalyst.

In embodiments, methods of lash extension application include, after applying the lash extension, measuring the temperature of the glue via the thermal camera and comparing it to an ambient temperature reference.

In embodiments, once the computer confirms the glue has reached the predetermined target temperature, it alerts the system that curing is complete, and the next lash extension application may be applied.

The present disclosure allows the ability to determine when glue is cured and a faster and more optimized lash extension application time.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a schematic diagram of a robotic system to automatically apply lash extensions;

FIG. 2 is a flow diagram of a method for applying lash extensions;

FIG. 3 is a graph illustrating time versus temperature for an endothermic glue and an exothermic glue;

FIG. 4 is a diagrammatical illustration of an image taken by an image camera;

FIG. 5 is a diagrammatical illustration of a processed image to identify individual natural lashes; and

FIG. 6 is a diagrammatical illustration of lash extensions and glue wells.

### DETAILED DESCRIPTION

Determining whether a glue is fully cured is an extremely difficult process since it can be a function of, for example, glue thickness, ambient temperature, and required holding force. Knowing when the glue has set sufficiently after applying a lash extensions is advantageous since a user needs to spend more time to ensure the lash is secure before proceeding with applying the next lash extension. Lash extensions can also be known as false eyelashes, artificial eyelashes, and the like.

The disclosure is a means of verifying whether glue has been cured using a thermal camera and measuring the endothermic and exothermic reactions of certain glues, such as UV curable, cyanoacrylate, and nitrocellulose glues.

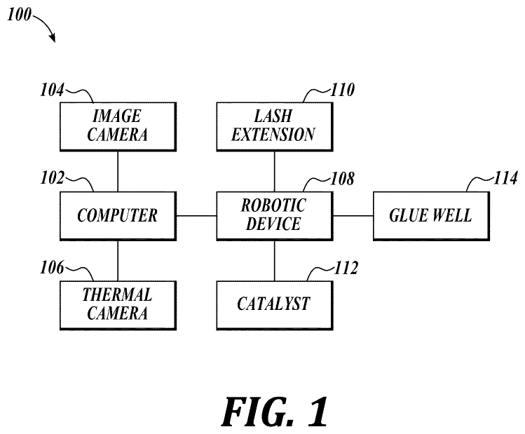

FIG. 1 is a schematic illustration of a system 100 to automatically apply a lash extension to a natural eyelash. The system 100 includes a computer 102, an image camera 104, a thermal camera 106, a robotic device 108, a supply of individual lash extensions, one or more glue wells 114 containing the glues, and optionally, a catalyst 112.

The system 100 may be implemented within a commercial salon as a desk top system with certain components of the system being supported to be in proximity to a person's face. The person receiving the lash extensions may be seated in a reclining chair with the robotic device 108, image camera 104, thermal camera 106 being supported on a mounting system to place these components in proximity to the person. In another embodiment, the system can exclude the robotic device 108 and the image camera 104.

For home use, for example, the system can include the computer 102, the thermal camera 106, the supply of individual lash extensions, the glue wells 114, and optionally, the catalyst 112. A difference between a system for commercial use, such as a salon, as compared to home use may be the elimination of the robotic device 108 to automatically pick up and place the lash extensions. In the home environment, a user of the system may manually pick up and place the lash extensions on the natural lashes. For use in a home environment, the system may be implemented as a hand-held device that can be aimed by the user at the user's lashes to analyze the temperature of the glue as it cures.

The computer 102 utilizes circuitry in order to implement the instructions and methods described herein, operatively connect two or more components, generate information, determine operation conditions, control the image camera, thermal camera, and robot. Circuitry of any type can be used. Circuitry includes, among other things, one or more computing devices or components such as a processor (e.g., a microprocessor), a central processing unit (CPU), a digital signal processor (DSP), an application-specific integrated circuit (ASIC), a field-programmable gate array (FPGA), or the like, or any combination thereof, and can include discrete digital or analog circuit elements or electronics, or combinations thereof.

The computer 102 includes one or more data stores that, for example, stores the instructions and data relating to the temperature characteristics of the glues, the target temperatures of each glue that determines the glue is sufficiently cured and has sufficient holding strength. Non-limiting examples of one or more data stores include volatile memory (e.g., Random Access memory (RAM), Dynamic Random Access memory (DRAM), or the like), non-volatile memory (e.g., Read-Only memory (ROM), Electrically Erasable Programmable Read-Only memory (EEPROM), Compact Disc Read-Only memory (CD-ROM), or the like), persistent memory, or the like. Further non-limiting examples of one or more data stores include Erasable Programmable Read-Only memory (EPROM), flash memory, or the like. The one or more data stores can be connected to, for example, one or more computing devices by one or more instructions, data, or power buses.

The computer 102 includes a computer-readable media drive or memory slot configured to accept signal-bearing medium (e.g., tangible computer-readable memory media, tangible computer-readable recording media, or the like). Software and/or hardware programmed for causing any device and/or the system to execute any of the disclosed instructions and methods can be stored on, for example, a tangible computer-readable recording medium (CRMM), a signal-bearing medium, or the like. Non-limiting examples of signal-bearing media include a recordable type medium such as any form of flash memory, magnetic tape, floppy disk, a hard disk drive, a Compact Disc (CD), a Digital Video Disk (DVD), Blu-Ray Disc, a digital tape, a computer memory, or the like, as well as transmission type medium such as a digital and/or an analog communication medium (e.g., a fiber optic cable, a waveguide, a wired communications link, a wireless communication link (e.g., transmitter, receiver, transceiver, transmission logic, reception logic, etc.). Further non-limiting examples of signal-bearing media include, but are not limited to, DVD-ROM, DVD-RAM, DVD+RW, DVD-RW, DVD-R, DVD+R, CD-ROM, Super Audio CD, CD-R, CD+R, CD+RW, CD-RW, Video Compact Discs, Super Video Discs, flash memory, magnetic tape, magneto-optic disk, MINIDISC, non-volatile memory card, EEPROM, optical disk, optical storage, RAM, ROM, system memory, web server, or the like.

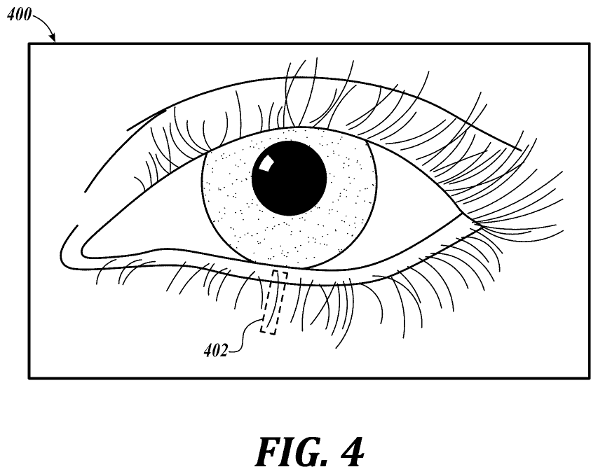

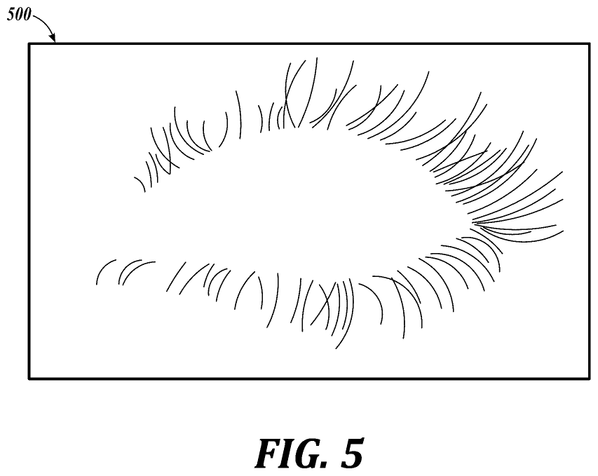

The image camera 104 includes a camera capable of capturing a visible light image of an area including natural eyelashes as illustrated in FIG. 4. The computer 102 and/or image camera 104 has software and/or hardware to analyze the visible light image to determine the characteristics of individual natural eyelashes. The system 100 is programmed to analyze and determine, for example, for each or some natural eyelashes, the eyelash length, the eyelash volume, the eyelash diameter, the eyelash curvature, the eyelash start and end, the eyelash position in space relative to other eyelashes or to facial features. The system 100 can create a processed image as illustrated in FIG. 5 from the visible light image from which the system can recognize and determine certain characteristics of the natural lashes 402. The system 100 uses the information from the image camera 104 to control the robotic device 108 to place a lash extension precisely on a chosen natural eyelash. The system 100 uses the information from the image camera 104 to aim the thermal camera 106 at the glue on the lash extension after the lash extension has been placed on the natural eyelash by the robotic device. The system 100 uses the information from the image camera 104 to identify the natural eyelashes that will receive a lash extension and the order of placing the lash extensions on the natural eyelashes. The system 100 uses the information from the image camera 104 to keep track of which natural eyelashes have received a lash extension and which natural eyelashes are remaining that need a lash extension. The system 100 uses the information from the image camera 104 to select one, all, or only some of the natural eyelashes that need a lash extension.

For the home, the system may exclude the image camera 104, since the user of the system can visually determine which eyelashes need lash extensions and manually place the lash extensions onto the natural lashes. The user can then manually aim the thermal camera 106 to measure the glue temperature. In the home use case, the computer 102 can be included with the thermal camera physically in the same enclosure, or the computer can be a separate unit or even a mobile device, such as a smart phone.

The thermal camera 106 includes a camera capable of determining the temperature of a small quantity of glue applied to a lash extension. The thermal camera 106 may rely on infrared radiation to determine the temperature of the glue. The thermal camera 106 and/or the computer 102 may include software and/or hardware to measure the temperature of the glue. The thermal camera and/or computer 102 may also measure the time along with measuring the temperature. The thermal camera 106 and/or the computer 102 may include software and/or hardware that compares the temperature of the glue on the lash extension to a predetermined target temperature stored in the system 100. The predetermined target temperature is a temperature at which the glue has been predetermined to be “cured” sufficiently such that the lash extension is held firmly and cannot be disturbed by further contact from either the robotic device 108 or manually. The system may produce a visual or audible cue that the glue has reached the predetermined target temperature. The robotic device 108 may proceed with placing the next lash extension when the glue temperature reaches the predetermined target temperature. Before the glue has reached the predetermined target temperature, the robotic device 108 may prepare by picking up the next lash extension and moving close to the user to minimize the time between lash extension applications. In the home system, a visual or audible cue signals the user to manually place the next lash extension.

The predetermined target temperature is stored in one or more data stores of the system 100. The predetermined target temperature is based on the glue composition and may also take into consideration other environmental factors, such as humidity, glue thickness, ambient temperature, and required holding force. One of several predetermined target temperatures may be used for a particular glue composition based on these or other factors. For example, the predetermined target temperature is the glue temperature minus the ambient temperature for exothermic glues or the predetermined target temperature is the ambient temperature minus the glue temperature for endothermic glues. This way the predetermined target temperature automatically takes the ambient temperature into account. The predetermined target temperature may also take time into consideration. For example, the system 100 may consider a glue to be cured when reaching a predetermined target temperature and after elapse of a time period. The predetermined target temperatures for each glue may be determined empirically by testing the glue holding force at a range of temperatures, ambient temperatures, glue thicknesses, etc. In the application of lash extensions, a thermal camera having a resolution of at least 160 by 120 sensors or pixels and a minimum frame rate of at least 10 fps can be suitable. However, higher resolutions and frame rates are also suitable.

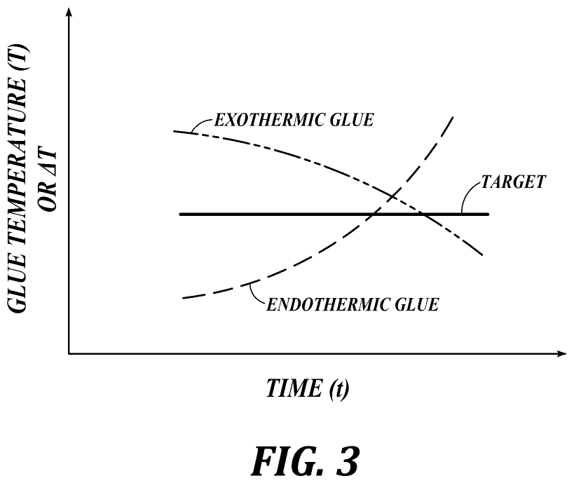

FIG. 3 is a graphical representation of glue temperatures versus time for a glue having an exothermic reaction and a glue having an endothermic reaction. The graph only shows the end portion of the temperature versus time curve. For an exothermic glue, the glue will initially reach a maximum temperature, then the exothermic glue will begin to cool to the ambient temperature as shown in the graph of FIG. 3. The predetermined target temperature for an exothermic glue is after the glue has reached the maximum temperature and has begun to cool down to the ambient temperature. Conversely, for an endothermic glue, the glue will initially reach a minimum temperature, then the endothermic glue will begin to heat up to the ambient temperature as shown in the graph of FIG. 3. The predetermined target temperature for an endothermic glue is after the glue has reached a minimum temperature and has begun to heat up to the ambient temperature. Examples of exothermic glues include cyanoacrylate glues, such as ethyl cyanoacrylate, and nitrocellulose glues. Examples of endothermic glues include UV-curable glues.

The robotic device 108 can be implemented in different configurations. The robotic device 108 may include an extending or telescoping robotic arm including pivoting points that is capable of moving a pair tweezers or any other pick up tool, in three axes or the robotic device may include a series of rails with a moving car including the tweezers that is also capable of moving in three axes. In either case, the robotic device 108 is capable of picking up individual lash extensions and is capable of moving along three-dimensional space in order to place the lash extension on the natural eyelash. Three axes refers to moving physically in three dimensions, i.e., up/down, left/right, and forwards/backwards. For use in a home environment, the robotic device 108 may be omitted as the user of the system can manually pick up lash extensions and place them on the natural lashes. Other pick up tools may use a vacuum to pick up and release lash extensions.

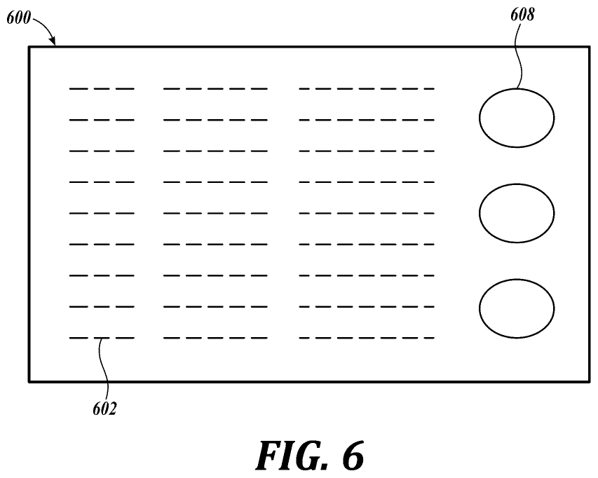

FIG. 6 is a diagrammatical illustration of a tray 600 containing the lash extensions 602. The lash extensions 602 may come in a variety of sizes, such as different diameter sizes and different lengths. The robotic device 108 is configured to pick up a lash extension 602 from the tray 600, dip the lash extension 602 into one or more glue wells 608, and then place the lash extension 602 on the natural eyelash that is determined by the image camera 104 and computer 102. The glue well 608 may be covered when not in use to prevent air, moisture, or light from prematurely curing the glue. The glue may be applied by dipping, or alternatively the glue may be coated by spraying or other suitable application method. The tray may include a designated place for individual lash extensions 602 so that the robotic device 108 knows precisely where each lash extension 602 of a particular size, diameter, is located. The system 100 keeps track of each lash extension on the tray 600 and knows which lash extensions have been used, which lash extensions remain, and can inform the user when the supply of lash extensions of a particular diameter or length has been exhausted.

A catalyst 112 is any means that increases the rate of curing, drying, or setting of a glue. Some glues will cure faster when in a high moisture environment. One catalyst is water that can be stored in a reservoir. The water can be atomized by means such as a piezoelectric element, and the atomized droplets of water can be dispensed by a nozzle on the robotic device 108 directly on the glue on the lash extension. Some glues will cure faster when heated, and therefore, one catalyst is laser light. For example, a fast pulse laser can be used to provide increases in the glue temperature. The laser can be placed on the robotic device 108. Other catalysts are chemical agents that can speed up the curing process of the glue. The application of a catalyst is optional, and the computer 102 has instructions that determine when and which catalyst to apply based on the glue being used.

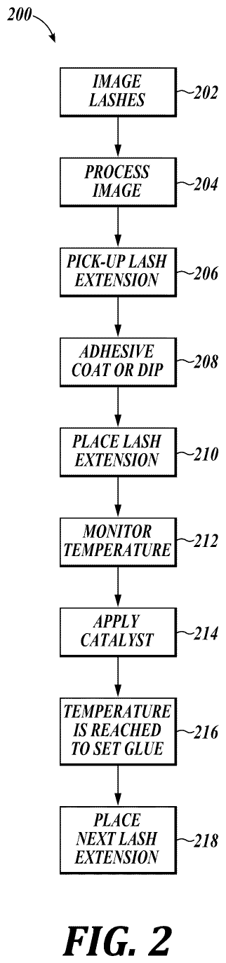

FIG. 2 is a step diagram describing a method for applying lash extensions. In step 202, the image camera 104 takes a visible light image of the eye area including the lashes.

In step 204, the visible light image is processed with software in order to determine certain characteristics of the natural lashes. The system 100 uses the processed image to control the robotic device 108 to place a lash extension precisely on a chosen natural eyelash. The system 100 uses the processed image to aim the thermal camera 106 at the glue on the lash extension after the lash extension has been placed on the natural eyelash by the robotic device 108. The system 100 uses the processed image to identify the natural eyelashes that will receive a lash extension and the order of placing the lash extensions on the natural eyelashes.

In step 206, the robotic device 108 picks up a lash extension that is determined by the computer 102. For use in the home, the system may omit the image camera 104 and the robotic device 108, since the user can determine which lashes will receive a lash extension.

In step 208, the robotic device 108 coats the lash extension with glue. Coating the glue may be performed by dipping the lash extension in a glue well or spraying the glue on the lash extension. In the home, the user can manually apply the glue to the lash extension by the dip or spray method.

In step 210, the robotic device 108 places the lash extension on the natural lash determined by the computer. The robotic device 108 uses the processed image to determine which natural lash receives the lash extension. The robotic device 108 uses the processed image to determine the spatial position of the natural lash.

After step 210, the thermal camera 106 begins to measure the glue temperature of the lash extension that has been applied by the robotic device 108 or manually by the user if there is no robotic device.

Step 214 is an optional step. If the computer 102 determines that a catalyst is required, for example, if the reaction is proceeding slowing, the computer 102 determines which catalyst to be applied and applies the catalyst.

In step 216, the temperature of the glue reaches the predetermined target temperature. Any time after the robotic device 108 places the lash extension on the natural lash, the robotic device 108 can release the lash extension. The robotic device 108 may release the lash extension immediately after placing the lash extension on the natural lash. The robotic device 108 may wait for a time period before releasing the lash extension or the robotic device 108 may release the lash extension based on a temperature of the glue to ensure a minimum holding force.

In step 216, when the temperature of the glue reaches the predetermined target temperature, the system may provide a visible or audible cue. The visible or audible cue informs the user that the next lash extension may be applied. The visible or audible cue can be provided in systems without a robotic device, so that the user can manually apply the next lash extension. The predetermined target temperature signifies that the robotic device 108 can apply the next lash extension, or for use in the home without a robotic device, the predetermined target temperature signifies that the user can apply the next lash extension.

In step 216, the predetermined target temperature is a temperature after the glue passes a maximum temperature when the glue is exothermic or after the glue passes a minimum temperature when the glue is endothermic.

In step 216, the predetermined target temperature is a temperature when the glue is in a cooling period when the glue is exothermic or when the glue is in a heating period when the glue is endothermic.

In step 216, the predetermined target temperature is a temperature difference of the glue temperature minus the ambient temperature for exothermic glues or the ambient temperature minus the glue temperature for endothermic glues.

After step 216, the next lash extension is applied to the next natural lash in step 218. Any time before the glue temperature reaches the predetermined target temperature, the robotic device 108 can pick up and be ready to apply the next lash extension. Before the glue temperature reaches the predetermined target temperature, the robotic device 108 has already picked up the next lash extension and is ready to immediately apply the next lash extension, minimizing the movements of the robotic device and decreasing the time period between applying lash extensions.

After a second and subsequent applications of lash extensions, the method returns to step 212 to measure the temperature of the glue of the lash extension that was most recently applied, and the steps 212 to 218 are repeated until completing the application of lash extensions for the natural lashes identified by the computer 102.

The present disclosure may reference quantities and numbers. Unless specifically stated, such quantities and numbers are not to be considered restrictive, but representative of the possible quantities or numbers associated with the present disclosure. Also, in this regard, the present disclosure may use the term “plurality” to reference a quantity or number. In this regard, the term “plurality” is meant to be any number that is more than one, for example, two, three, four, five, etc. The terms “about,” “approximately,” “near,” etc., mean plus or minus 5% of the stated value. For the purposes of the present disclosure, the phrase “at least one of A, B, and C,” for example, means (A), (B), (C), (A and B), (A and C), (B and C), or (A, B, and C), including all further possible permutations when greater than three elements are listed.

The detailed description set forth above in connection with the appended drawings, where like numerals reference like elements, are intended as a description of various embodiments of the present disclosure and are not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or substantially similar result. Some steps may be omitted and the order of steps may be re-arranged. Generally, the embodiments disclosed herein are non-limiting, and the inventors contemplate that other embodiments within the scope of this disclosure may include structures and functionalities from more than one specific embodiment shown in the figures and described in the specification.

In the foregoing description, specific details are set forth to provide a thorough understanding of example embodiments of the present disclosure. It will be apparent to one skilled in the art, however, that the embodiments disclosed herein may be practiced without embodying all the specific details. In some instances, well-known process steps have not been described in detail in order not to unnecessarily obscure various aspects of the present disclosure. Further, it will be appreciated that embodiments of the present disclosure may employ any combination of features described herein.

The present disclosure may include references to directions, such as “vertical,” “horizontal,” “front,” “rear,” “left,” “right,” “top,” and “bottom,” etc. These references, and other similar references in the present application, are intended to assist in helping describe and understand the particular embodiment (such as when the embodiment is positioned for use) and are not intended to limit the present disclosure to these directions or locations.

The principles, example embodiments, and modes of operation of the present disclosure have been described in the foregoing description. However, aspects of the present disclosure, which are intended to be protected, are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure as claimed.

While illustrative embodiments have been illustrated and described, it will be appreciated that various changes can be made therein without departing from the spirit and scope of the invention.

The embodiments of the invention in which an exclusive property or privilege is claimed are defined as follows:

1. A system, comprising:
a thermal camera;
a robotic device;
lash extensions;
a glue well including a glue that undergoes exothermic or endothermic reaction;
a computer and a tangible computer-readable medium having stored thereon instructions that when executed perform the following steps:
control the robotic device to pick up a lash extension;
control the robotic device to apply glue to the lash extension;
control the robotic device to place the lash extension on a natural lash;
control the robotic device to release the lash extension;
measure, via the thermal camera, a temperature of the glue on the lash extension placed on the natural lash; and
after the temperature of the glue is at a predetermined target temperature, the robotic device places a second lash extension on a second natural lash.

1. The system of claim 1, wherein the predetermined target temperature is a temperature difference of the glue temperature minus the ambient temperature for exothermic glues or the ambient temperature minus the glue temperature for endothermic glues.

3. The system of claim 1, wherein the predetermined target temperature is a temperature after the glue passes a maximum temperature when the glue is exothermic or after the glue passes a minimum temperature when the glue is endothermic.

4. The system of claim 1, wherein the predetermined target temperature is a temperature when the glue is in a cooling period when the glue is exothermic or when the glue is in a heating period when the glue is endothermic.

5. The system of claim 1, wherein the tangible computer-readable medium further has stored thereon instructions that when executed perform the following step:
control the robotic device to pick up the second lash extension before the temperature of the glue is at the predetermined target temperature.

6. The system of claim 1, further comprising a catalyst to increase a rate of reaction of the glue.

7. The system of claim 6, wherein the catalyst is moisture or laser light.

8. The system of claim 1, further comprising an image camera to capture a visible light image of natural lashes.

9. The system of claim 8, wherein the tangible computer-readable medium further has stored thereon instructions that when executed perform the following step:
determine a natural lash position from the visible light image used in controlling the robotic device to place the lash extension on the natural lash.

10. The system of claim 9, wherein the tangible computer-readable medium further has stored thereon instructions that when executed perform the following step:
determine a diameter of the natural lash or a length of the natural lash.

11. The system of claim 1, further comprising lash extensions of different lengths or diameters.

12. The system of claim 1, wherein the tangible computer-readable medium further has stored thereon instructions that when executed perform the following step:
measure a length of time that the glue is at the predetermined target temperature.

2. The system of claim 1, wherein the tangible computer-readable medium further has stored thereon instructions that when executed perform the following step:
measure a length of time after the robotic device releases the lash extension on the natural lash.

14. The system of claim 1, wherein the tangible computer-readable medium further has stored thereon instructions that when executed perform the following step:
when the temperature of the glue reaches the predetermined target temperature, the robotic device places the second lash extension on the second natural lash.

15. A method for gluing lash extensions on natural lashes, comprising:
gluing a first lash extension on a natural lash; and
gluing a second lash extension on a second natural lash after a temperature of a glue on the first lash extension reaches a predetermined target temperature.

3. The method of claim 15, further comprising,
providing a visible or audible cue when the temperature of the glue on the first lash extension reaches the predetermined target temperature.

17. The method of claim 15, further comprising,
gluing the first lash extension with a robotic device and gluing the second lash extension with the robotic device immediately after the temperature of the glue on the first lash extension is at the predetermined target temperature.

4. The method of claim 15, wherein the predetermined target temperature is a temperature difference of the glue temperature minus the ambient temperature for exothermic glues or the ambient temperature minus the glue temperature for endothermic glues.

19. The method of claim 15, wherein the predetermined target temperature is a temperature after the glue passes a maximum temperature when the glue is exothermic or after the glue passes a minimum temperature when the glue is endothermic.

5. The system of claim 15, wherein the predetermined target temperature is a temperature when the glue is in a cooling period when the glue is exothermic or when the glue is in a heating period when the glue is endothermic.
